(19) United States
(12) Patent Application Publication
(10) Pub. No.: US 2022/0361452 A1
(43) Pub. Date: Nov. 17, 2022

(54) PET TOY WITH DENTAL BENEFIT

(71) Applicant: John J. Stone, Golden, CO (US)

(72) Inventor: John J. Stone, Golden, CO (US)

(21) Appl. No.: 17/321,428

(22) Filed: May 15, 2021

(51) Int. Cl. A01K 15/02

(52) U.S. Cl. CPC A01K 15/026

(57) ABSTRACT

The invention comprises a pet plush toy wherein an animal character is attached to a “stalk” as a monkey would cling to a tree, and which provides a dental benefit when pets chew a portion of the tree stalk created from braided jersey fabric that is removeable from the stalk portion to provide extra play as well as dental benefits when a pet chews the strands of the braid. Elastic in the arms of the animal character allow it to be slipped over the stalk portion, and also contains noisemakers in both the animal and the stalk or portion they are elastically clung to. The toy is thus 2 pieces that an animal may remove from one another and individually play with each piece. The braided jersey piece may be reinserted an infinite number of times to reengage pet play.

### FIELD

The invention relates to a novel pet plush toy wherein an animal character is attached to a “stalk” as a monkey would cling to a tree, and which provides a dental benefit when pets chew a portion of the tree stalk created from braided jersey fabric. The stalk portion has individual pieces of jersey sticking out therefrom and helps clean pet's teeth as they chew it. Elastic in the arms of the animal character allow it to be slipped over the stalk portion, and also contains noisemakers in both the animal and the stalk or portion they are elastically clung to.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet plush toy wherein an animal character is attached to a “stalk” as a monkey would cling to a tree, and which provides a dental benefit when pets chew a portion of the tree stalk created from braided jersey fabric. The stalk portion has individual pieces of jersey sticking out therefrom and helps clean pet's teeth as they chew it. Elastic in the arms of the animal character allow it to be slipped over the stalk portion, and also contains noisemakers in both the animal and the stalk or portion they are elastically clung to.

The inventive toy provides multiple levels of amusement for pets, but also presents with a dental aid via the strands of jersey material, which, when chewed, act as floss for a pet's teeth.

### THE INVENTION

### Summary, Objects and Advantages

The arms and legs of the animal characters are piece constructed and contain no fill. Elastic inside the “arms” of the animal allow them to be stretched enough to place on the stalk portion and removably slide down the stalk to be detached. A noisemaking device or squeaker is set inside the body of the animal character.

The stalk portion is turned construction with lining and contains a braided jersey rope inside which extended out an end of the stalk. The stalk portion also contains polyfill in ⅓ of its internal mass. Cellophane type crinkle material is also contained in the stalk portion to create a variety of attractant sounds to a pet.

The head of the animal character is of 3D construction with poly fill inside, set to animal body, and contains facial feature embroidery details. It is obvious that multiple animal characters may be used. Applicant illustrates a monkey and a koala bear as embodiments herein.

### BRIEF DESCRIPTION OF THE DRAWINGS

The invention is described in further detail by reference to nine (9) drawings sufficient in detail to describe the invention in which:

FIG. 1 is a side view of the stalk and animal arms and head;

FIG. 2 is a front perspective of the stalk with the monkey character holding on;

FIG. 3 is a rear perspective of the monkey holding on to the stalk;

FIG. 4 is a disassembled view of the monkey and the stalk;

FIG. 5 is an example of the koala bear embodiment stalk and animal arms and head;

FIG. 6 is a front perspective of the stalk with the koala character holding on;

FIG. 7 is a rear perspective of the koala holding on to the stalk;

FIG. 8 is a disassembled view of the monkey and the stalk; and

FIG. 9 is an illustration of the squeaking devices.

### DETAILED DESCRIPTION, INCLUDING BEST MODES OF CARRYING OUT THE INVENTION

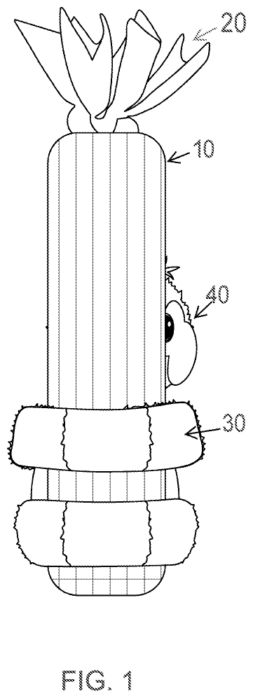

FIG. 1 illustrates the embodiment of the monkey character holding on to the stalk 10. Elastic in the monkey's limbs 30 allow it to be slid off the stalk by manipulation with the toy by the pet or by a pet owner. The monkey's head 40 is partially shown in this view. Strips of the jersey braided internal rope 20 are seen extending from the top of the stalk providing a dental chew for the pet. As it chews the individual strand of jersey, teeth cleaning occurs.

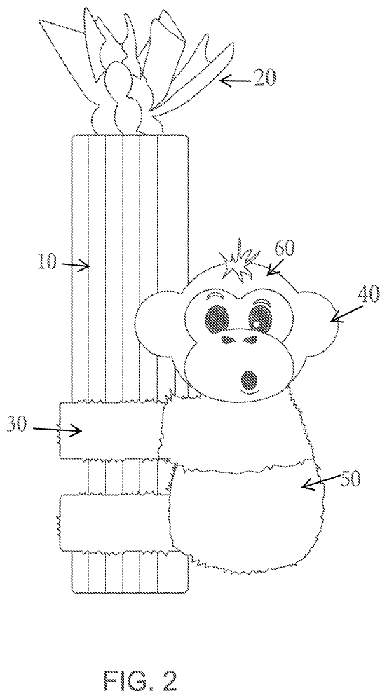

FIG. 2 is a front facing view of the monkey and stalk wherein the body 50 is also visible. Again, the strands of jersey 20 are seen extending from the top of the stalk 10 and the head of the monkey 40 is shown in full view. The jersey rope is braided and inserted into the stalk, and which braided rope may be pulled from the stalk by a pet or a pet owner. Embroidered facial features 60 are shown. Embroidery and printing may be used to create an animal character's facial features.

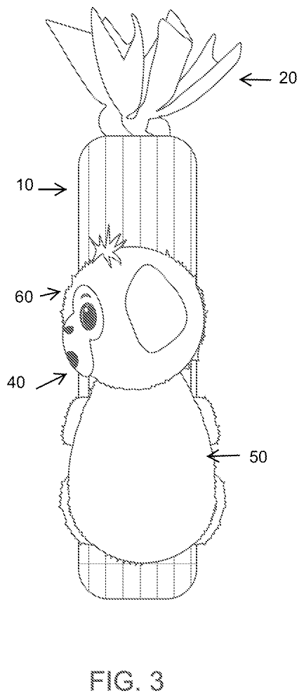

FIG. 3 is a rear perspective of the monkey and stalk. Elasticized arms 30 encircle the stalk and the stands of jersey extend from the top of the stalk. It should be noted that the stalk has a hole in the top wherein the braided rope may be removed and reinserted an infinite number of times. The deconstruction feature aids in an owner being able to wash the portions of the toy when desired.

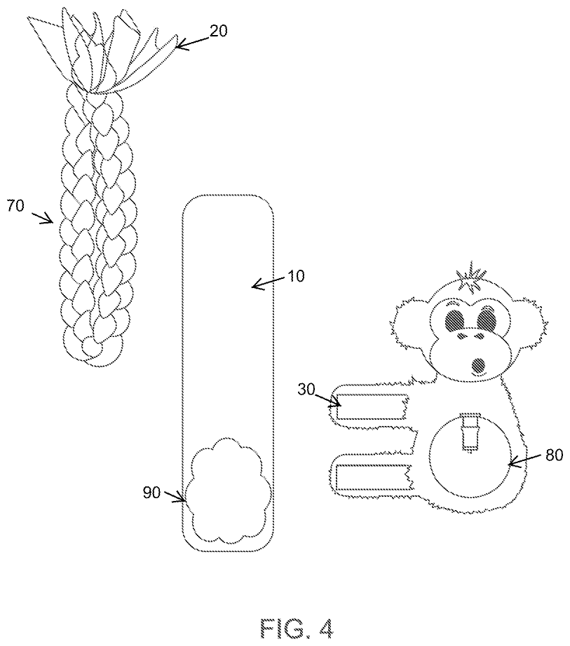

FIG. 4 is key in illustrating the separate pieces of the toy. The braided portion of the jersey rope 70 can be seen as well as the strands 20 which extend from the top of the stalk 10 when the rope is inserted properly. The noisemaker 80 is shown in phantom inside the animal character's body and will create sounds when a pet compresses the toy. Only the lower ¼^{th} portion of the stalk contains polyfill 90 to add malleability to the stalk. Elastic sections in the animal's arms/limbs 30 is shown in phantom. This allows the animal character to be removed by a pet or by a pet owner for additional play and/or cleaning.

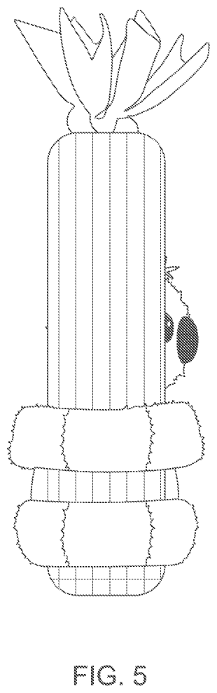

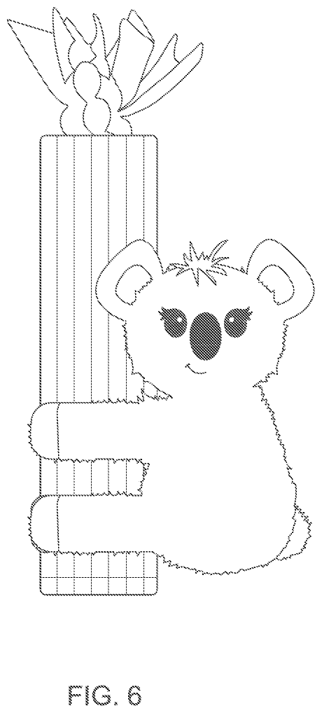

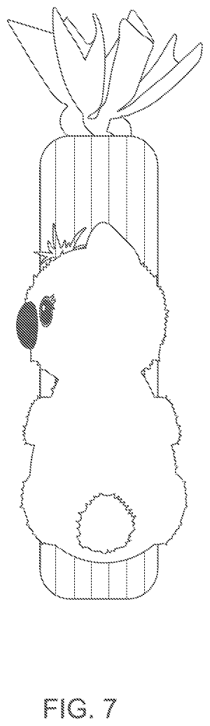

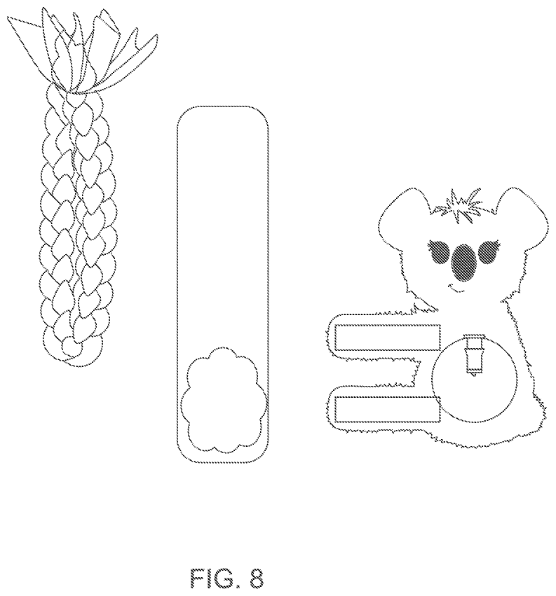

FIGS. 5-8 are duplications of the toy and exception being the embodiment is simply the koala bear version of the same toy. It is appreciated that many different animal characters can be used in this toy design, and thus it is not limited to the two embodiments presented.

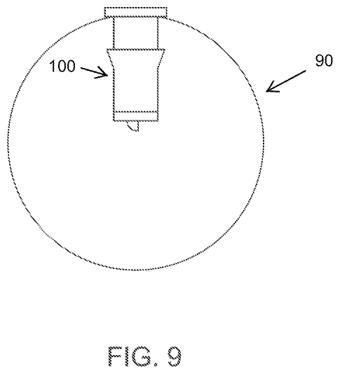

FIG. 9 is an illustration of the round bladder 80 with a set-in reed squeaker 100 as may be inserted into the animal body as well as the stalk portion.

1) A plush two-piece pet toy comprising;
b) a plush head and body animal character with facial features
c) a plush stalk portion wherein the animal character is removably affixed
d) elasticized limbs which removably encircle the stalk
e) only one-fourth of the stalk portion containing polyfill
f) a braided section of jersey fabric with distal strands extending from the end of the rope and which rope is insertable within the stalk portion
d) a noisemaker within the head of the animal character; and
e) cellophane inserted into the body of the stalk or the animal character

2) A plush two-piece pet toy as in claim 1 wherein the animal character's body is piece constructed of plush material and contains no fill.

3) A plush two-piece pet toy as in claim 1 wherein the plush head of the animal character is 3D construction with polyfill inside, set to animal body, and with embroidered facial features.

4) A plush two-piece pet toy as in claim 1 wherein elastic sewn inside the animal's limbs allow for expansion to be slidably removed from the stalk portion for pet play or for cleaning.

5) A plush two-piece pet toy as in claim 1 wherein one-fourth of the stalk portion contains polyfill material.

6) A plush two-piece pet toy as in claim 1 wherein a section of braided jersey fabric extends through an opening in the stalk portion, and which has distal strands that extend from the stalk to provide chewing pieces with dental benefits as the strands clean the teeth of an animal.

7) A plush two-piece toy as in claim 1 wherein a circular hollow bladder contains a reed squeaker within and is located within the head of the animal character.

8) A plush two-piece pet toy as in claim 1 wherein a cellophane material may be inserted into the body of the animal character or within the stalk for added sound production.
